(19) United States
(12) Patent Application Publication
(10) Pub. No.: US 2010/0034943 A1
(43) Pub. Date: Feb. 11, 2010

(54) System and Methods for On Demand Iced Tea

(75) Inventor: Jonathan Kirschner, Powder Springs, GA (US)

Correspondence Address: SUTHERLAND ASBILL & BRENNAN LLP, 999 PEACHTREE STREET, N.E., ATLANTA, GA, 30309, US

(73) Assignee: The Coca-Cola Company, Atlanta, GA (US)

(21) Appl. No.: 12/188,250

(22) Filed: Aug. 8, 2008

(51) Int. Cl. A23F 3/00; A47J 31/40; A47J 31/18

(52) U.S. Cl. 426/435; 99/302 P

(57) ABSTRACT

An on demand ice tea brewing system. The tea brewing system may include a concentrated tea brewer with a brewing chamber for brewing a concentrated tea, a piston positioned within the brewing chamber, and a mixing area for diluting the concentrated tea with an amount of diluent so as to provide a diluted tea. The tea brewing system also may include a dispensing nozzle in communication with the concentrated tea brewer to dispense the diluted tea.

### TECHNICAL FIELD

The present application relates generally to systems and methods for brewing tea and more particularly relates to systems and methods for brewing highly concentrated tea and then quickly diluting the concentrated tea so as to provide iced tea on demand.

### BACKGROUND OF THE INVENTION

Numerous methods are known for providing tea and other types of steeped beverages. These methods range from the use of traditional teabags to the use of tea extracts and concentrates. The traditional teabag can provide a high quality cup of tea but the teabag generally is not well suited for providing larger volumes of tea, at least not within a small amount of time. Tea extracts and concentrates may quickly provide larger volumes of tea and also may have extended shelf life. The quality of the tea produced from such extracts and concentrates, however, often is not as high as the tea made from traditional teabags.

Further issues may be involved in the brewing of tea intended to be served as iced tea. After brewing, the tea generally must be cooled to at least room temperature before adding ice or the ice may melt and dilute the tea. Further, sweeteners and flavoring often are added to the tea. These additives, however, generally must be measured and mixed in by hand. The preparation of iced tea thus may be a somewhat time intensive process.

There is a desire, therefore, for improved systems and methods of brewing high quality iced tea in larger volumes but in smaller amounts of time than may be possible with the use of traditional teabags. The systems and methods described herein preferably should produce a high quality and a high volume of iced tea in an efficient and cost effective manner.

### SUMMARY OF THE INVENTION

The present application thus provides a tea brewing system. The tea brewing system may include a concentrated tea brewer with a brewing chamber for brewing a concentrated tea, a piston positioned within the brewing chamber, and a mixing area for diluting the concentrated tea with an amount of diluent so as to provide a diluted tea. The tea brewing system also may include a dispensing nozzle in communication with the concentrated tea brewer so as to dispense the diluted tea.

The tea brewing system further may include one or more tea sources in communication with the concentrated tea brewer, one or more additive sources in communication with the dispensing nozzle, an ice dispenser, and a display for selecting a tea beverage. The dispensing nozzle may include an elongated target. The additive sources may include sweeteners, flavorings, colors, and/or functional additives. The concentrated tea brewer may include an upper cap in communication with the brewing chamber. The upper cap may include a filter and a blunt edge for disposing of spent tea leaves. The mixing area may be positioned about the upper cap. The concentrated tea may include a concentration of more than about five (5) to one (1) and less than about eight (8) to one (1) and more specifically a concentration of about 6.75 to 1.

The present application further provides a method of brewing tea on demand. The method may include brewing a dose of tea leaves in a brewing chamber to produce a concentrated tea, forcing the concentrated tea out of the brewing chamber, squeezing the dose of tea leaves so as to force a further amount of concentrated tea out of the brewing chamber, mixing the concentrated tea with an amount of diluent to produce a diluted tea, and dispensing the diluted tea for consumption from a dispensing nozzle.

The method further may include the step of adding the dose of tea leaves to the brewing chamber. The adding step may include adding only the dose of tea leaves to the brewing chamber. The step of squeezing the dose of tea leaves may include forming the dose of tea leaves into a puck. The method further may include the step of ejecting only the puck from the brewing chamber.

The method further may include the step of mixing the diluted tea with one or more additives at the dispensing nozzle. The additives may include sweeteners, flavorings, colors, and/or functional additives. The step of brewing a dose of tea leaves to produce a concentrated tea may include producing the concentrated tea with a concentration of more than about five (5) to one (1) and less than about eight (8) to one (1) and more specifically a concentration of about 6.75 to 1. The method further may include flowing an additional amount of water after the brewing, the forcing, and the squeezing steps are complete.

The present application further may provide a method of brewing tea on demand. The method may include adding only a dose of tea leaves to a brewing chamber, adding hot water to the brewing chamber, brewing the dose of tea leaves to produce a concentrated tea, mixing the concentrated tea with an amount of diluent to produce a diluted tea, dispensing the diluted tea for consumption from a dispensing nozzle, and mixing the diluted tea with one or more additives at the dispensing nozzle.

The method further may include the step of squeezing the dose of tea leaves so as to force the concentrated tea out of the brewing chamber. The step of brewing a dose of tea leaves to produce a concentrated tea may include producing the concentrated tea with a concentration of more than about five (5) to one (1) and less than about eight (8) to one (1).

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of an iced tea brewing system as is described herein.

FIG. 2 is a side plan view of the exterior of the iced tea brewing system of FIG. 1.

FIG. 3 is a side cross-sectional view of a tea brewer as may be used with the iced tea brewing system of FIG. 1.

FIG. 4A is a side cross-sectional view of the brewing chamber of the tea brewer of FIG. 3 shown with a piston in a retracted position.

FIG. 4B is a side cross-sectional view of the brewing chamber of the tea brewer of FIG. 3 with the piston in an extended position.

### DETAILED DESCRIPTION

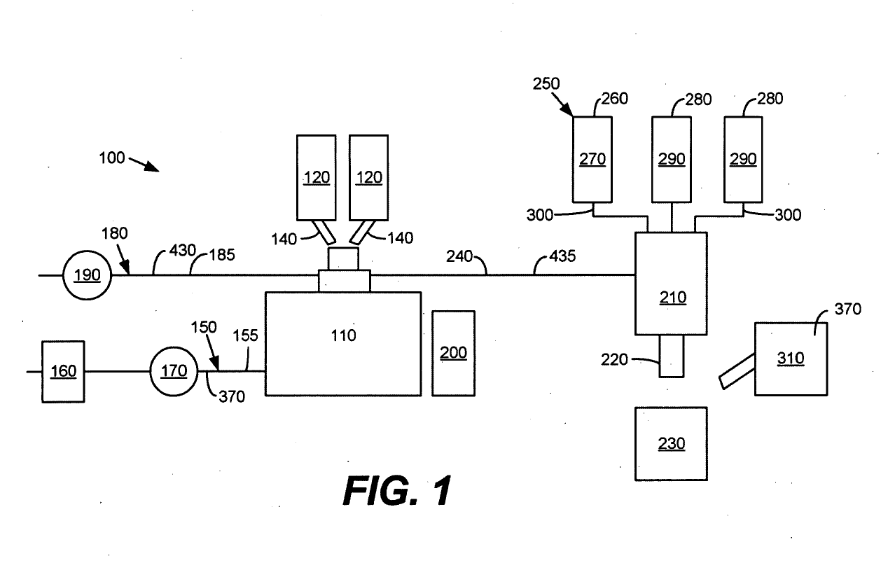

Referring now to the drawings, in which like numbers refer to like elements throughout the several views, FIG. 1 shows an iced tea brewing system 100 as is described herein. The iced tea brewing system 100 includes a tea brewer 110. As will be described in more detail below, the tea brewer 100 may be a brewing device sold by de Jong Duke of Sliedrecht, Netherlands, under the trademark “COEX®”. Similar types of brewing devices may be used herein.

The iced tea brewing system 100 further includes one or more tea sources 120. Any number of tea sources 120 may be used. The tea sources 120 generally may hold loose, bulk tea leaves 130. The tea leaves 130 may include black teas, green teas, white teas, oolong teas, combinations, or any type processed leaves, herbal teas, or similar materials. The tea sources 120 may have any desired volume or shape. A dose of the tea leaves 130 may be fed to the tea brewer 100 via one or more tea chutes 140 in communication with the tea sources 120 or via other types of feeding mechanisms.

The iced tea brewing system 100 also may include a hot water source 150 with hot water 155 therein in communication with the tea brewer 110. The hot water source 150 may include a conventional water source in communication with a boiler 160. The boiler 160 may any type of conventional water heating device that can bring the water to a boil or close thereto. The hot water source 150 also may include a hot water pump 170 in communication with the boiler 160. The hot water pump 170 may be of conventional design.

The iced tea brewing system 100 further may include a make up water source 180 with cool make up water 185 or other type of diluent therein in communication with the tea brewer 110. The make up water source 180 may be in communication with a conventional water supply and the tea brewer 110 via a make up water pump 190. The make up water pump 190 may be of conventional design and may be similar to the hot water pump 170 described above.

The iced tea brewing system 110 further may include a spent tea receptacle 200. The spent tea receptacle 200 may be positioned adjacent to the tea brewer 10. The spent tea receptacle 200 may accept the spent tea leaves 130 from the tea brewer.

The iced tea brewing system 100 also may include a dispensing nozzle 210. The dispensing nozzle 210 may be similar to that shown in commonly owned U.S. Pat. No. 7,383,966 to Ziesel, entitled “Dispensing Nozzle”; U.S. Patent Publication No. 2006/0191964 to Ziesel, entitled “Dispensing Nozzle”; U.S. Patent Publication No. 2007/0205219 to Ziesel, entitled “Dispensing Nozzle Assembly”; and/or U.S. patent application Ser. No. 11/782,833 to Ziesel, entitled “Dispensing Nozzle Assembly.” U.S. Pat. No. 7,383,966; U.S. Publication No. 2006/0191964; U.S. Publication No. 2007/0205219; and U.S. Ser. No. 11/782,833 are incorporated herein by reference in their entirety. Similar types of nozzles may be used herein.

In this example, the dispensing nozzle 210 may include a central elongated target 220 so as to mix the various fluids herein and direct the mixed fluid stream towards a container 230. Other types of mixing devices may be used herein. The container 230 may be a single serving sized cup or the container 230 may take the form of a pitcher or other type of receptacle for larger volumes of tea. The dispensing nozzle 210 may be in communication with the tea brewer 110 via a brewed tea line 240.

The iced tea brewing system 100 also may include a number of additive sources 250. The additive sources 250 may include one or more sweetener sources 260. The sweetener sources 260 may include one or more sweeteners 270 therein. The sweeteners 270 may be natural or artificial sweetener. The sweeteners 270 may include sucrose, high fructose corn syrup, and/or other types of conventional sweeteners. The additive sources 250 also may include a number of flavoring sources. The flavoring sources 280 may include one or more flavorings 290 therein. The flavorings 290 may be juice concentrates, syrups, or similar types of materials. For example, the flavoring 290 may include lemon, peach, or any other type of fruit or other flavorings. The additive sources 250 also may include natural or artificial colors; additives for controlling tartness, e.g., citric acid or potassium citrate; functional additives such as vitamins, minerals, herbal extracts, nutraceuticals, and over the counter (or otherwise) medicines such as acetaminophen; and/or any other desired type of materials. The additive sources 250 may be in communication with the dispensing nozzle 210 via one or more additive lines 300. Any number of additive lines 300 may be used.

The iced tea brewing system 100 also may include an ice dispenser 310. The ice dispenser 310 may be positioned about the dispensing nozzle 210 or otherwise so as to provide ice 320 to the container 230 or otherwise. Alternatively, the ice dispenser 310 may be remote from the iced tea brewing system 100. Various types of refrigeration means also may be used herein.

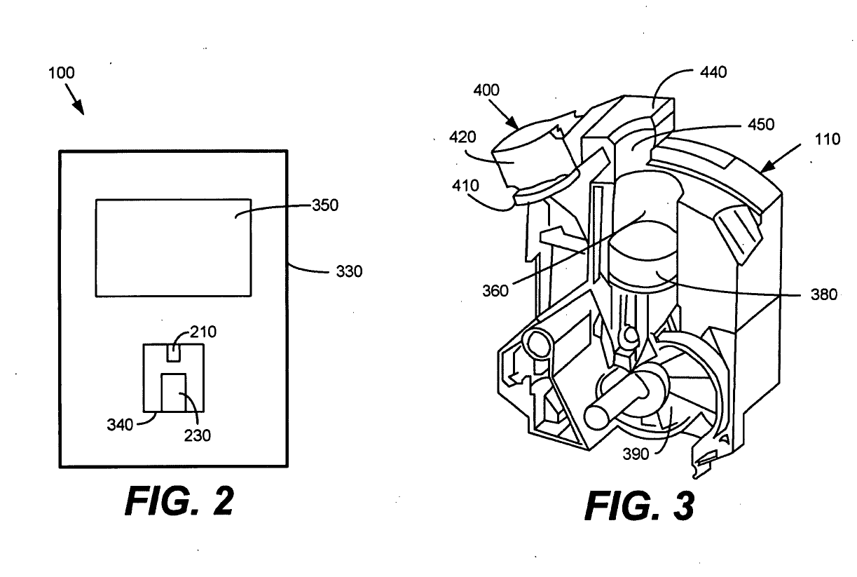

As is shown in FIG. 2, the components of the iced tea brewing system 100 described above may be positioned within an enclosure 330. The enclosure 330 may include a support 340 for the container 230 to rest thereon while being filled with a beverage via the dispensing nozzle 210. The enclosure 330 of the iced tea brewing system 100 also may include a display 350 positioned thereon. The display 350 may be any type of selection device in which a consumer may select a beverage. These selections may include black or green tea leaves 130 from the tea sources 120 and various types of additives such as the sweeteners 270, the flavorings 290, and the like from the additive sources 250. The addition of ice 320 from the ice dispenser 310 also may be selected. Any other type of selection means may be used herein. The display 350 may be interactive. The display 350 and the iced tea brewing system 100 as a whole may be networked so as to provide communications concerning diagnostics, dispensing volume, payment, resupply, selection changes, and the like.

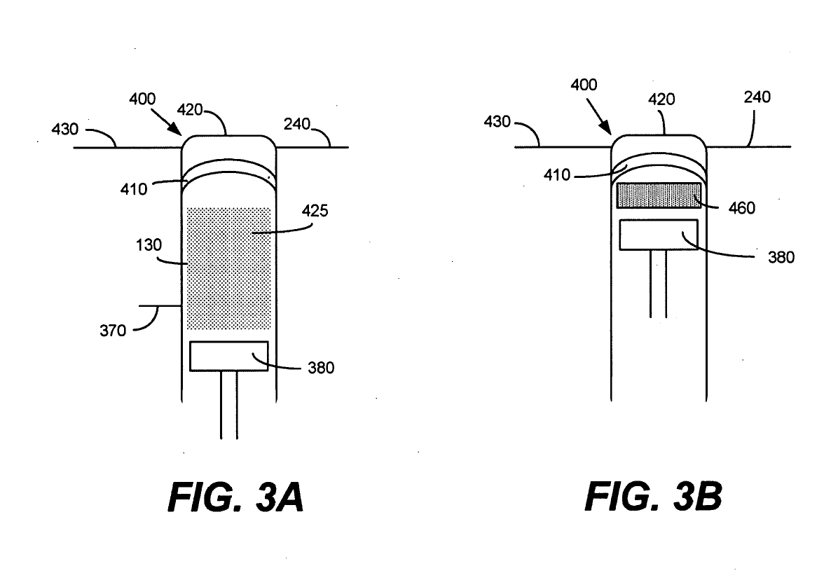

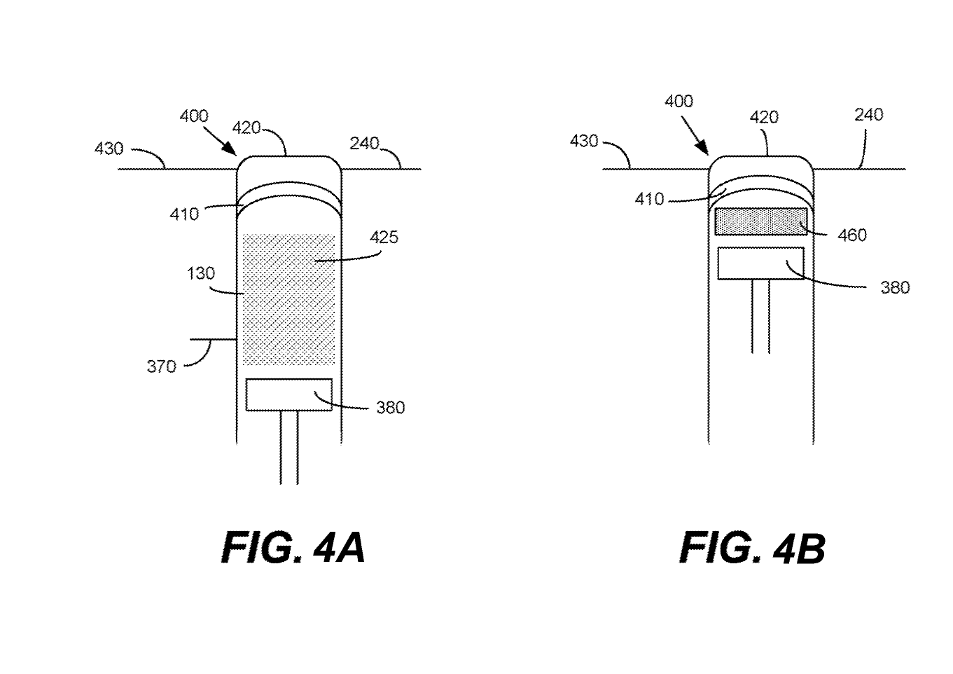

FIGS. 3, 4A, and 4B show the tea brewer 110 in more detail. The tea brewer 110 may include an internal brewing chamber 360. The internal brewing chamber 360 is in communication with the hot water source 150 via a hot water line 370. The internal chamber 360 may include a piston 380 positioned therein. The piston 380 may be of conventional design. The piston 380 forms a largely water tight seal within the internal brewing chamber 360. The piston 380 may move up and down within the internal brewing chamber 360 as driven by an eccentric cam 390. Other types of drive mechanisms may be used herein.

The internal brewing chamber 360 of the tea brewer 110 may be enclosed by an upper cap 400. The upper cap 400 may be maneuverable into an open and shut position by the eccentric cam 390 or via other types of drive mechanisms. The upper cap 400 may include a filter 410. The filter 410 may be a metallic filter that is sized to let the brewed tea pass therethrough under pressure but maintain the tea leaves 130 therein. The upper cap 400 also may include a mixing area 420. The mixing area 420 allows for mixing an amount of concentrated, brewed tea 425 with the make up water 185 from the make up water system 180 via a make up water line 430. An amount of the diluted tea 435 then may be forwarded to the dispensing nozzle 210 via the brewed tea line 340. The mixing area 420 also may be remote from the internal brewing chamber 360. The mixing area 420 may be simply a three way valve connecting the make up water line 430, the internal brewing chamber 360, and the brewed tea line 240 or the mixing area 420 may include a chamber connecting each of these elements.

The upper cap 400 also may include a blunt edge 440 on one side thereof. The blunt edge 440 serves to knock the spent tea leaves 130 into the spent tea receptacle 200. Other types of discard mechanisms may be used herein. The upper cap 400 also may include a nozzle 450 for accepting the tea leaves 230 from the tea sources 120. Other types of in-flow mechanisms also may be used herein.

In use, a consumer may select an iced tea beverage via the display 350. For example, the consumer may select black tea and then select additives such as a sweetener 270, a flavoring 290, and ice 320. The iced tea brewing system 100 then may release a dose of tea leaves 130 from one of the tea sources 120 into the nozzle 450 of the tea brewer 110. The tea leaves 130 may fall into the internal brewing chamber 360 of the tea brewer 110. Note that paper filters, bags, or other types of paper sources may not be needed within the internal brewing chamber 360.

As is shown in FIG. 4A, once the tea leaves 130 are positioned within the internal brewing chamber 360, the upper cap 400 of the tea brewer 110 closes the internal brewing chamber 360. Hot water 155 from the hot water source 150 then flows into the internal brewing chamber 360 via the hot water line 370 first to provide a preinfusion dose of the hot water 155 and then to brew the concentrated tea 425. The hot water 155 preferably is at about 98° Celsius (about 208° Fahrenheit). Other temperatures may be used herein, preferably between about 90° Celsius to about 100° Celsius (about 194° Fahrenheit to about 212° Fahrenheit). The tea leaves 130 may take about 20 to about 30 seconds to brew, with about 23 to about 25 being preferred. Other brewing times may be used herein. The brewing pressure also may vary.

As the brewing cycle ends, the piston 380 extends within the internal brewing chamber 360 as is shown in FIG. 4B. This upward movement forces the brewed concentrated tea 425 through the filter 410 and into the mixing area 420. The brewed concentrated tea 425 may have a concentration of about 6.75 to 1. Any concentration greater than about 4:1 and less than about 8:1 may be used herein. The brewed concentrated tea 425 then may be mixed with the make up water 185 from the make up water system 180 via the make up water line 430. The brewed concentrated tea 425 thus is diluted into the diluted tea 435 and may be forwarded to the dispensing nozzle 210 via the brewed tea line 240.

The piston 380 then may continue to extend within the internal brewing chamber 360. In further extending, the piston 380 compacts the tea leaves 130 into a puck-like structure 460. The compression also squeezes the tea leaves 130 such that an additional amount of the brewed concentrated tea 425 (with the brewed tea solids therein) is forced through the filter 410 and into the mixing area 420. This final squeezing step appears to provide a higher quality tea beverage perhaps with more tea solids and other types of tea components than can be provided without compression. The squeezed amount appears to be the mostly highly concentrated part of the brewed concentrated tea 425. By way of example, if about 100 milliliters of brewed concentrated tea 425 pass into the mixing area 420 via the piston 380, this final squeezing step may add about an extra 15 milliliters or so. (This squeezed amount generally is discarded when brewing coffee as being too bitter for consumption.) The total of about 115 milliliters of brewed concentrated tea 425 is then mixed with about 775 milliliters of make up water for the concentration of about 6.75 to 1.

The piston 380 then may retract somewhat while the upper cap 400 opens the internal brewing chamber 360. The piston 380 then extends again so as to raise the puck 460 out of the internal brewing chamber 360. The upper cap 400 again pivots such that the blunt edge 440 knocks the puck 460 into the spent tea receptacle 200. The iced tea brewing system 100 thus generates no waste other than the spent tea leaves 130 in the form of the puck 460.

As described above, the diluted tea 435 passes through the dispensing nozzle 210 via the brewed tea line 240. The make up water system 180 continues flowing the make up water 185 through the mixing area 420 of the upper cap 400 and into the brewed tea line 240 for an amount of time after the squeezing step is completed so as to clear the mixing area 420 and the brewed tea line 240 of any remaining tea. The diluted tea 435 passes through the dispensing nozzle 210 and passes along the elongated target 220 towards the container 230. The iced tea brewing system 100 also mixes in the selected additives at this time. For example, a sweetener 270 from the sweetener source 260 mixes with the diluted tea 435 along the elongated target 220. Likewise, the selected flavorings 290 from the flavoring sources 280 also mix along the elongated target 220 and fall towards the container 230. Finally, the iced tea brewing system 100 also may include an amount of ice 320 from the ice dispenser 310 if desired.

The iced tea brewing system 100 thus can make any desired volume of iced tea on demand in a fast and efficient manner. Because the dilution ratio of the concentrated brewed tea 425 to the make up water 185 is relatively high, the make up water 185 brings the concentrated brew tea 425 to a lower temperature such that ice can be added immediately to the diluted tea 435 without causing the ice to melt prematurely. Likewise, the iced tea brewing system 100 automatically adds and mixes additives such as the sweeteners 270 and the flavorings 290 to the container 230 in the correct proportions. Further, the iced tea brewing system 100 has no waste other than the spent tea leaves 130. The systems and methods described herein thus provide high volumes of fresh brewed ice tea in a fast and efficient manner. For example, more than a liter of iced tea may be brewed in less than about one (1) minute or so.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A tea brewing system, comprising:
a concentrated tea brewer;
the concentrated tea brewer comprising:
a brewing chamber for brewing a concentrated tea;
a piston positioned within the brewing chamber; and
a mixing area for diluting the concentrated tea with an amount of diluent so as to provide a diluted tea; and
a dispensing nozzle in communication with the concentrated tea brewer to dispense the diluted tea.

2. The tea brewing system of claim 1, further comprising one or more tea sources in communication with the concentrated tea brewer.

3. The tea brewing system of claim 1, wherein the dispensing nozzle comprises an elongated target.

4. The tea brewing system of claim 1, further comprising one or more additive sources in communication with the dispensing nozzle.

5. The tea brewing system of claim 4, wherein the one or more additive sources comprise sweeteners, flavorings, colors, and/or functional additives.

6. The tea brewing system of claim 1, further comprising an ice dispenser.

7. The tea brewing system of claim 1, further comprising a display for selecting a tea beverage.

8. The tea brewing system of claim 1, wherein the concentrated tea brewer comprises an upper cap in communication with the brewing chamber.

9. The tea brewing system of claim 8, wherein the upper cap comprises a filter.

10. The tea brewing system of claim 8, wherein the mixing area is positioned about the upper cap.

11. The tea brewing system of claim 8, wherein the upper cap comprises a blunt edge for disposing of spent tea leaves.

12. The tea brewing system of claim 1, wherein the concentrated tea comprises a concentration of more than about five (5) to one (1) and less than about eight (8) to one (1).

13. The tea brewing system of claim 1, wherein the concentrated tea comprises a concentration of about 6.75 to 1.

14. A method of brewing tea on demand, comprising:
brewing a dose of tea leaves in a brewing chamber to produce a concentrated tea;
forcing the concentrated tea out of the brewing chamber;
squeezing the dose of tea leaves so as to force a further amount of concentrated tea out of the brewing chamber;
mixing the concentrated tea with an amount of diluent to produce a diluted tea; and
dispensing the diluted tea for consumption from a dispensing nozzle.

15. The method of claim 14, further comprising the step of adding the dose of tea leaves to the brewing chamber and wherein the adding step comprises adding only the dose of tea leaves to the brewing chamber.

16. The method of claim 14, wherein the step of squeezing the dose of tea leaves comprises forming the dose of tea leaves into a puck.

17. The method of claim 16, further comprising the step of ejecting only the puck from the brewing chamber.

18. The method of claim 14, further comprising the step of mixing the diluted tea with one or more additives at the dispensing nozzle.

19. The method of claim 18, wherein the step of mixing the diluted tea with one or more additives comprises mixing the tea with sweeteners, flavorings, colors, and/or functional additives.

20. The method of claim 14, wherein the step of brewing a dose of tea leaves to produce a concentrated tea comprises producing the concentrated tea with a concentration of more than about five (5) to one (1) and less than about eight (8) to one (1).

21. The method of claim 14, wherein the step of brewing a dose of tea leaves to produce a concentrated tea comprises producing the concentrated tea with a concentration of about 6.75 to 1.

22. The method of claim 14, further comprising flowing an additional amount of water after the brewing, the forcing, and the squeezing steps are complete.

23. A method of brewing tea on demand, comprising:
adding only a dose of tea leaves to a brewing chamber;
adding hot water to the brewing chamber;
brewing the dose of tea leaves to produce a concentrated tea;
mixing the concentrated tea with an amount of diluent to produce a diluted tea;
dispensing the diluted tea for consumption from a dispensing nozzle; and
mixing the diluted tea with one or more additives at the dispensing nozzle

24. The method of claim 23, further comprising the step of squeezing the dose of tea leaves so as to force the concentrated tea out of the brewing chamber.

25. The method of claim 23, wherein the step of brewing a dose of tea leaves to produce a concentrated tea comprises producing the concentrated tea with a concentration of more than about five (5) to one (1) and less than about eight (8) to one (1).
